(19) United States
(12) Patent Application Publication
(10) Pub. No.: US 2007/0276736 A1
(43) Pub. Date: Nov. 29, 2007

(54) Transaction processing

(75) Inventor: Kieron Guilfoyle, Dublin (IE)

Correspondence Address: JACOBSON HOLMAN PLLC, 400 SEVENTH STREET N.W., SUITE 600, WASHINGTON, DC, 20004, US

(73) Assignee: SNAPCOUNT LIMITED

(21) Appl. No.: 11/642,058

(22) Filed: Dec. 20, 2006

Related U.S. Application Data
(63) Continuation of application No. 11/206,077, filed on Aug. 18, 2005.
Application No. 11/206,077 is a continuation of application No. PCT/IE04/00032, filed on Mar. 8, 2004.

(30) Foreign Application Priority Data
Mar. 7, 2003 (IE) 2003/0165

(51) Int. Cl. G06Q 20/00

(52) U.S. Cl. 705/17; 235/380

(57) ABSTRACT

A customer purchases a voucher by presenting a security card at a point-of-sale terminal (1). The terminal (11) communicates with a remote EPOS host (10) to validate the security data. The host (10) communicates with a transaction processor (30) to generate voucher data. Operations of the terminal (1) are triggered by a program read from the security card together with the security data. The host (10) splits the full voucher data into a first set transmitted to the terminal (1) and a second set transmitted over the air via a gateway (14) to a customer mobile device (20). The host (10) dynamically maintains a voucher database (12) and a security data database (13) in response to ongoing communication with the terminals (1) and the transaction processors (30).

This is a Continuation of application Serial No. 11/206,077, filed Aug. 18, 2005, which in turn is a PCT continuation of PCT/IE2004/000032, filed Mar. 8, 2004 and published in English.

### INTRODUCTION

1. Field of the Invention

The invention relates to transaction processing and payment instrument issuance mechanisms.

2. Prior Art Discussion

Internet commerce has been increasing in recent years, and the predominant payment method is by way of credit and debit cards. However, a limit on use of credit cards for transactions with remote retailers has been reluctance of customers to transmit credit card details over the internet due to security concerns.

One approach to addressing this problem has been for customers to register with a merchant so that the details are transmitted only once and a password is used thereafter. This is of benefit where a customer intends to regularly use a particular merchant, such as an airline. However it allows little flexibility.

Another approach has been to issue limited use credit cards, such as described in EP1029311B 1 (Orbis Patents Limited). In this approach, there is a pool of credit card numbers at least one of which is a master number and another is a limited use number. The limited-use number is used without revealing the master number, and it is deactivated according to a use-triggered condition. This approach is of benefit, however it is limited to use by customers who have a credit card account. U.S. Pat. No. 5,943,423 (Entegrity Solutions) describes a token system in which there is communication between a user and a server with PKI encryption and security data to obtain access to network resources. This appears to be cumbersome for the user.

U.S. Pat. No. 6,1923,249 describes a mechanism in which a smart card is loaded with an electronic ticket. While this appears to be useful for certain circumstances, it does require the customer to have a smart card and to engage in a client/server download process which may be complex and/or inconvenient.

U.S. Pat. No. 6,370,514B1 (Messner) describes a system for issuing vouchers for use in on-line purchases. Problems with this approach include that vouchers generated must be redeemed for a particular vendor's gift certificates before being used in a transaction. This two-stage process limits the usability of the system.

WO01/67407 (Technocash Inc.) describes a system for issuing electronic tokens in the form of a physical card. Markings on the card include serial numbers and a monetary value. Disadvantages of this approach are that it creates a system which does not appear to interoperate with existing card infrastructures.

The invention is directed towards providing an improved mechanism for issuing payment instruments and for using them for transactions.

### SUMMARY OF THE INVENTION

According to the invention, there is provided a method of generating a payment instrument voucher for use in card-not-present transactions such as online transactions, the method comprising the steps of:
a point-of-sale terminal in a retailer premises receiving customer security data;
the point-of-sale terminal communicating with a remote host to validate the customer security data;
if validation is positive, the point-of-sale terminal receiving voucher request data;
the point-of-sale terminal transmitting a voucher request message to the remote host, and the host responding with a request response; and
the point-of-sale terminal outputting voucher data in return for receiving payment by the customer, if the host response is positive.

In one embodiment, the host generates a full set of voucher data, transmits a first set of the voucher data to the point-of-sale terminal, and transmits a second set of the voucher data directly to the customer.

In another embodiment, the first set of voucher data includes a voucher number and the second set includes a voucher security code.

In a further embodiment, the second set is transmitted as a message to a customer's mobile device.

In one embodiment, the message is an SMS message.

In another embodiment, the host includes a gateway linked with a mobile telecommunications network for transmitting the second set of voucher data.

In one embodiment, the point-of-sale terminal prints the terminal voucher data.

In one embodiment, the terminal prints the voucher data to provide a physical printed voucher.

In a further embodiment, the customer security data is read from a card presented by the customer and having the security data recorded thereon.

In one embodiment, the security data is magnetically encoded on the card.

In another embodiment, the card includes a trigger program, and the point-of-sale terminal executes said program to cause automatic activation of a voucher purchase launch program on the terminal.

In a further embodiment, the launch program automatically presents the point-of-sale operator with a menu of possible voucher values.

In one embodiment, the terminal automatically generates a voucher request message for the host using the security data and the value selection.

In another embodiment, the voucher request message includes only the security code and the requested voucher value.

In a further embodiment, the host dynamically maintains a database of security data and a database of issued voucher data linked with the security data.

In one embodiment, the step of the host generating the voucher data includes:
transmitting a voucher request message to a transaction processor,
the transaction processor allocating a voucher number,
the transaction processor returning the voucher number to the host.

In another embodiment, the voucher request message transmitted to the host includes only a request code and the value.

In a further embodiment, the transaction processor allocates a PAN number as the voucher number, said number being suitable for processing in a subsequent transaction in a manner similar to that of a debit or credit card number.

In one embodiment, the method comprises the further steps of the transaction processor receiving a request for validation of the voucher for a proposed transaction from a card-not-present merchant system, verify the voucher number, and transmitting a message to the host to indicate that the voucher has been used or partly used.

In another embodiment, the host automatically updates a voucher database.

In another aspect, the invention provides a method of operation of a transaction processor, comprising the steps of the processor:
receiving a voucher request from a point-of-sale system, satisfying the request by generating or selecting a voucher number, transmitting the voucher number to the point-of-sale system, and updating a voucher database accordingly;
subsequently, receiving a transaction request from a card-not-present merchant system, identifying a voucher number in the request, and determining if the transaction should be authorised according to the voucher database and a transaction database; and
after completion of the transaction, transmitting a message to the host system including details of the transaction.

In one embodiment, the voucher request received from the point-of-sale system includes only a request indicator and a value indicator and is of common, fixed length format.

In another embodiment, the point-of-sale system is a point-of-sale host, in turn linked with a plurality of remote point-of-sale terminals.

The invention also provides, together or separately, a point-of-sale terminal, a point-of-sale host, and a transaction processor each comprising means for performing associated steps of any of the methods defined above.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a block diagram of systems involved in implementing a method of the invention;

FIG. 2 is a representation of the layout of a voucher printed at a point-of-sale terminal in a method of the invention, and FIG. 3 is a representation of the layout of a merchant receipt printed at the terminal;

FIGS. 4(a), 4(b), and 4(c) are flow diagrams illustrating methods of the invention; and

FIG. 5 is a representation of an over-the-air transmission.

### DESCRIPTION OF THE EMBODIMENTS

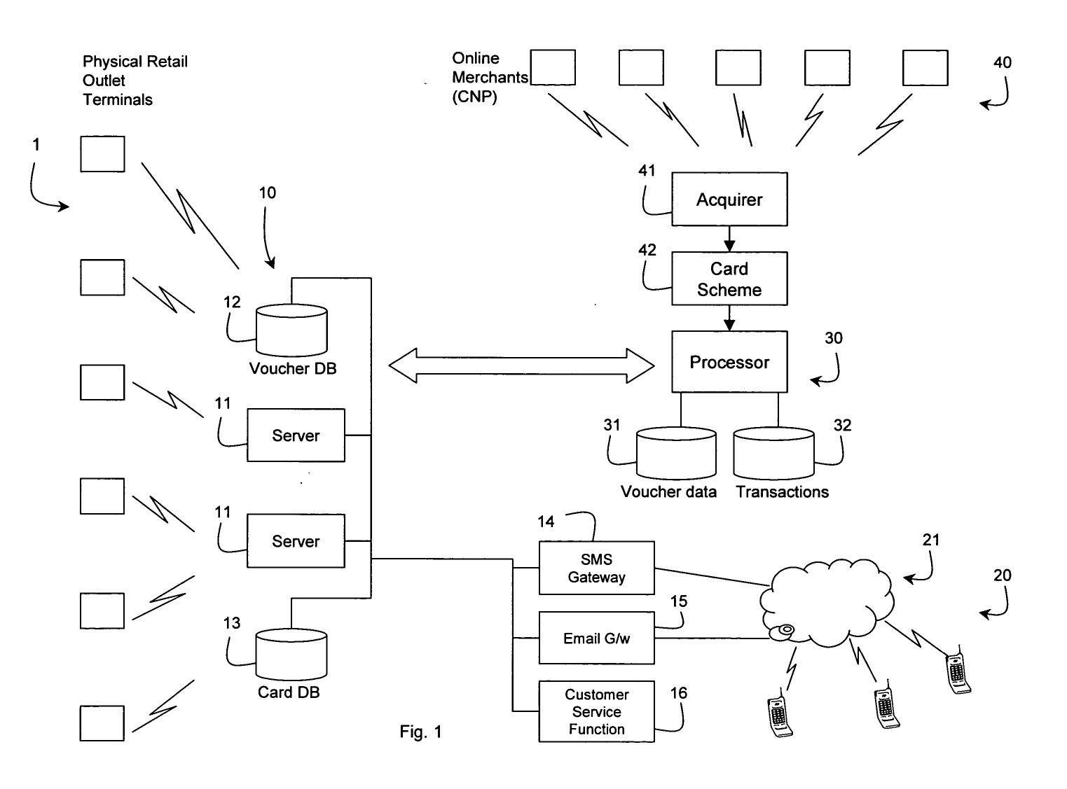

Referring to FIG. 1 systems involved in implementing methods of the invention are illustrated. Terminals 1 located at physical retail outlets are linked with an electronic point-of-sale (“EPOS”) host 10. The host 10 comprises two servers 11 in a mirroring arrangement for automatic backup. The host 10 also comprises, in a clustering arrangement, a database 12 for voucher data and a database 13 for security card data. The host 10 is linked with communication systems including in this embodiment an SMS gateway 14, an email gateway 15, and a customer service function 16. The gateways 14 and 15 communicate with customer devices such as mobile phones 20 via mobile networks 21. The host 10 is linked with a remote transaction processor 30, having a voucher database 31 and a transaction database 32.

The processor 30 is also linked with online, card-not-present (CNP) merchant systems 40 via an acquirer system 41 and a card scheme 42.

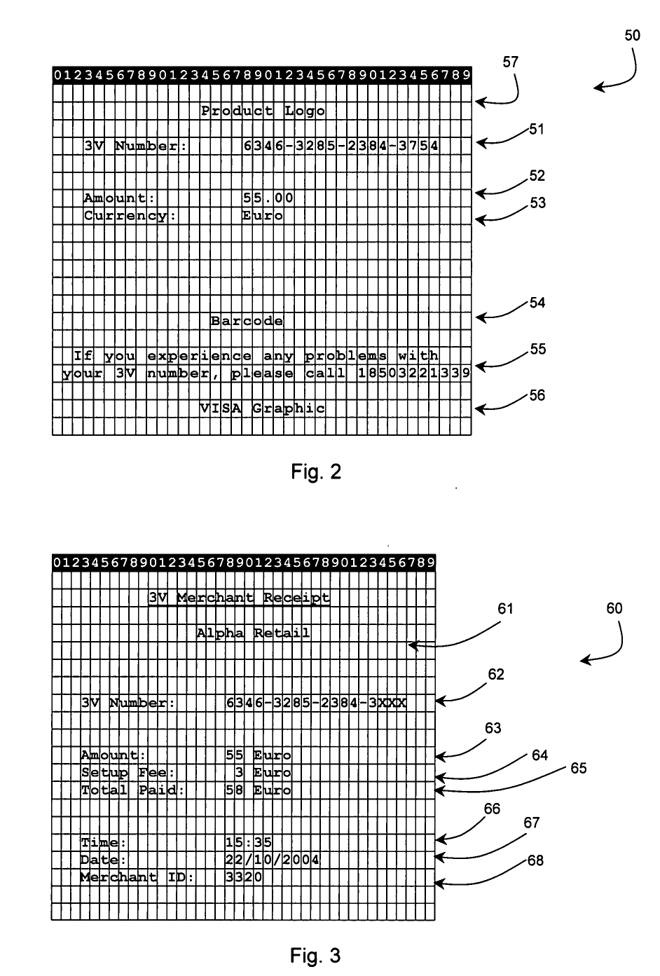

Referring to FIG. 2 a voucher 50 is generated at a point-of-sale terminal 1. It may be paid for in cash or in any other payment form such as debit card. The voucher is printed by a printer of the type used for other transactions such as purchase receipts. The printed fields include the following.
51: a voucher number in the same format (PAN) as that of a credit card number;
52: an amount;
53: a currency denomination;
54: a barcode
55: a customer message; and
56,57: branding logos

The voucher may only be used for a transaction in conjunction with separate codes/data transmitted separately over-the-air by the gateways 14 or 15, as described in more detail below.

The voucher 50 may be used by anyone to whom it has been given. In one example, a parent purchases the voucher and gives it to his or her child to use for an online purchase. This avoids the need for the parent to allow the child have use of his or her credit card account. The voucher may alternatively be purchased by a customer who does not have a credit card, for use in making online purchases. Referring to FIG. 3, at the same time as printing the voucher 50, the merchant point-of-sale terminal also prints a merchant receipt 60 having fields for:
61: merchant text,
62: voucher (“3V”) number,
63: amount,
64: setup fee,
65: total paid,
66,67: voucher issuance time, and date, and
68: merchant identifier.

In general, the customer can engage in any of the following activities relating to the vouchers.
(a) Use a voucher in a series of Card Not Present Transactions. The vouchers are usable in any transaction where a physical card is not required.
(b) Perform a balance enquiry via a website. Customers can find out on a website the remaining balance on a voucher and previous transaction history. They login to a website using the unique number issued with each voucher.
(c) Redeem a voucher by sending it to the voucher issuer which hosts the processor 30.
(d) Customers can convert a voucher to cash by filling in a downloadable form and posting it to the voucher issuer. They will receive a cheque or money order for the voucher value.
(e) Transfer balances from one voucher to another either online or over the telephone.

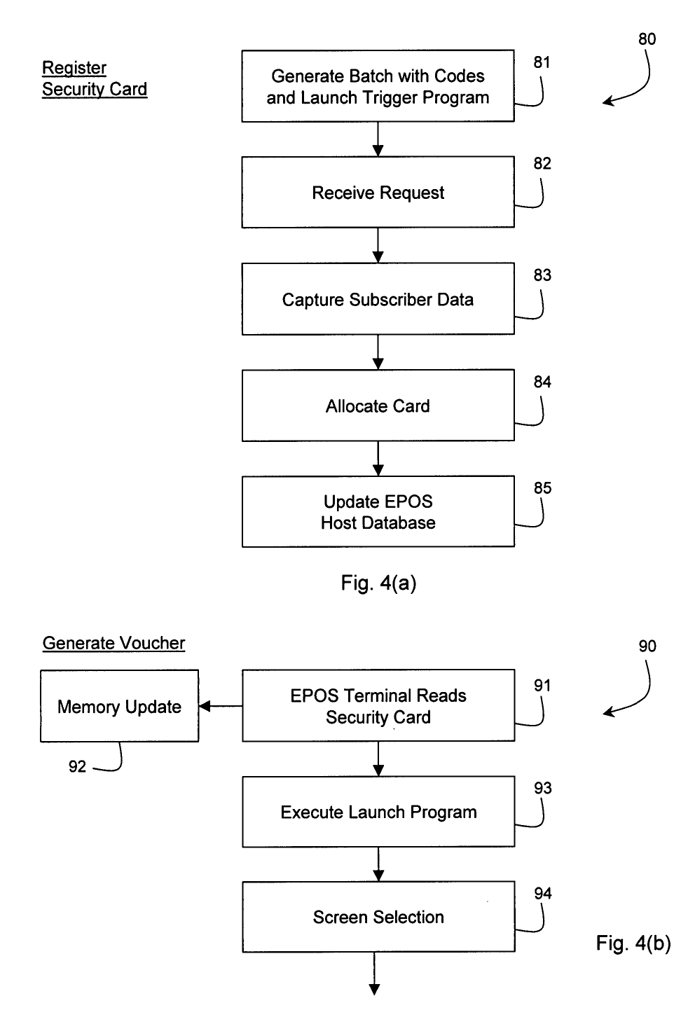

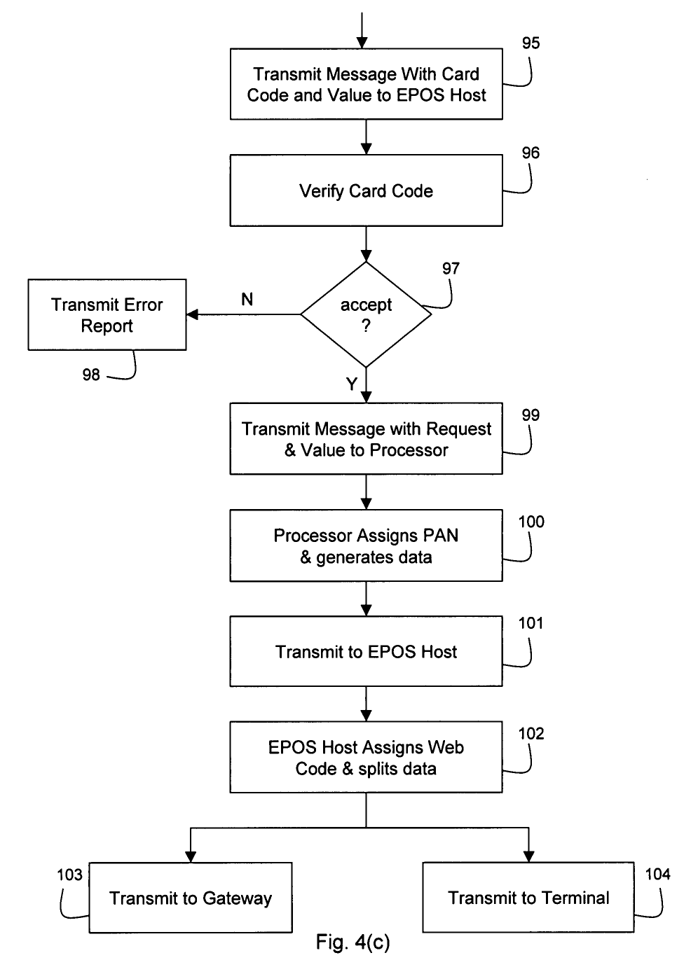

Referring to FIG. 4(a) a process 80 for issuing a security card is illustrated. The security card has a magnetic stripe. It is carried by the customer for use in purchasing vouchers from time to time. A batch of cards is generated in step 81. Each card of the batch has a unique identifier and a common trigger program encoded in its magnetic stripe. In step 82, an organisation responsible for issuing security cards receives a request from a customer via any convenient channel such as physically visiting an issuing desk, by email, or by a Web form. Subscriber data is captured in step 83 including the subscriber's name, address, date of birth, telephone numbers, and email address. Also, a password is collected. The server allocates a card to the subscriber in step 84. In step 85 the security card database 13 is updated with the subscriber data and the linked security code data.

Referring to FIGS. 4(b) and 4(c) a process 90 for generating a voucher for a subscriber is illustrated. The subscriber presents his/her security card at a “physical” merchant's premises. The premises may be a retail outlet of any type, the only requirement being that it operates a point-of-sate terminal 1. The terminal 1 reads the data from the security card when it is “swiped” in step 91, and in step 92 it updates a local memory dataset with the read card code. The terminal 1 also reads and uploads the trigger program and upon executing this program a launch program in the terminal 1 is executed in step 93. This generates a simple display of a menu of possible voucher values on a touch screen, in step 94.

Upon receiving a selection made by the point-of-sale operator, the terminal 1 generates a message in step 95, including the card code and value. This message is transmitted to the host 10. It will be appreciated that this message is short, requiring little of the point-of-sale network bandwidth.

The host 10 receives the message, and in step 96 it verifies the card code. An error message is transmitted back in step 97 to the terminal 1 if the card code is marked in the database 13 as invalid. This may be the case if the code was not issued in an authorised manner, or if the card has been reported as lost or stolen.

The host 10 then generates a short message for onward transmission to the processor 30 if the card code is valid in step 99. This message includes only the voucher request and the selected value. This message has a fixed, predetermined length, again minimising bandwidth requirements on the host-processor link.

The processor 30 does not need to perform any validating operations. It simply, in step 100, assigns a number in the industry-standard PAN 16-digit format. The number is selected from a batch with a BIN (Bank Identification Number) range, in a manner akin to issuance of credit card numbers.

The PAN is transmitted to the host 10 in step 101, together with associated data including the amount, currency, and expiry.

At the host 10 a “Web code” is assigned to the PAN, and a full voucher dataset is completed. The full dataset includes:
the PAN number,
amount,
currency,
purchase time and date,
web code
expiry date,
security code (3 digits).

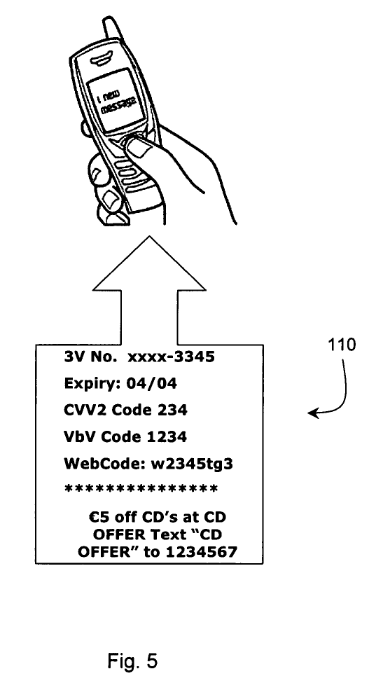

The host 10 automatically splits the data into that used for printing the voucher (shown in FIG. 2) and that for electronic transmission as shown in FIG. 5. The former is transmitted to the terminal 1 for printing the voucher 50, shown in FIG. 2. The latter is routed to one of the gateways 14 or 15 for onward over-the-air transmission separately to the customer as a message 110. The subscriber can not make a purchase unless he/she has both the printed voucher data and also the information transmitted over-the-air.

The voucher is used for transactions with card-not-present merchants having systems 40. To make a purchase, the voucher number is entered on the web site or via telephone in the normal manner for a debit card (or credit card) transaction. The site will also require the user to enter the 3-digit “CVV2” code transmitted over-the-air as shown in FIG. 5. The merchant system 40 communicates with an acquirer system 41, which in turn communicates via a card scheme 42 with the processor 30. The processor 30 performs authorisation with reference to the databases 31 and 32. Thus, the CNP merchant systems 40 operate in a conventional manner, treating the number and code as if they were from a credit or debit card. The processor 30 is in a position to dynamically update both voucher issuance data and also transaction data arising from use of the vouchers. Each voucher customer is represented as a row of data in a ‘Cash Customer Table’ of the database 13 of the EPOS host 10. Each issued voucher is represented as a row in ‘3V table’ of the database 12. There is a relationship between the relevant ‘Cash Customer Table’ and the ‘3V Table’. Each transaction that occurs for a voucher—e.g. issuance and redemption is a separate row in a ‘Transaction Table’ of the database 32. Each row in this table is linked back to a row in the ‘3V table’ of the database 12.

The following represents the Cash Customer Table.

| # | Type | Name | Description |
|---|---|---|---|
| 1 | Int (16) | ID | Automatically generated by |
| | | | Database |
| 2 | String (40) | First_Name | First Name of Customer |
| 3 | String (40) | Middle_Name | Middle Name of Customer |
| 4 | String (40) | Last_Name | Second Name of Customer |
| 5 | String (20) | Date_Of_Birth | Date of Birth of Customer |
| 6 | String (40) | Nationality | Nationality of Customer |
| 7 | String (1) | Gender | Gender of Customer-M = |
| | | | Male, F = Female |
| 8 | String (40) | Address 1 | 1^{st} Line of Customer Address |
| 9 | String (40) | Address 2 | 2^{nd} Line of Customer Address |
| 10 | String (40) | Address 3 | 3^{rd} Line of Customer Address |
| 11 | String (40) | Address 4 | 4^{th} Line of Customer Address |
| 12 | Date | Application_Date | Date of receipt of |
| | | | ISC Application. |
| 13 | Date | Document_Return_Date | Date of return of Identity |
| | | | Documents |
| 14 | Date | ISC_Issue_Date | Date of issue of ISC |
| 15 | String (20) | ISC ID. | Identity of ISC Card-this |
| | | | value is on magnetic stripe |
| | | | of ISC Card and is used to |
| | | | uniquely identify customers. |
| 16 | Int (2) | Status | Code describing status of |
| | | | Customer: |
| | | | 0 = Active-customer allowed |
| | | | purchase voucher. |
| | | | 1 = InActive-customer not |
| | | | allowed purchase voucher. |
| | | | 2 = Pending-customer not |
| | | | allowed purchase voucher. |

The following represents the 3V table of the database 12.

| # | type | Name | Description |
|---|---|---|---|
| 1 | Int (16) | ID | Automatically generated by |
| | | | Database. |
| 2 | String (16) | PAN | 16 Digit PAN. |
| 3 | String (5) | Expiry | Expiry Date of PAN. |
| 4 | String (3) | CVV | Security Code. |
| 5 | Date | Issue_Date | Date of issue of 3V. |
| 6 | Time | Issue Time | Time of issue of 3V. |
| 7 | String (1) | Type | H = Cash, D = Card. |
| 8 | Int (16) | Cash_Customer_ID | ID of Cash Customer if this is |
| | | | a Cash 3V. |
| 8 | String (16) | 3V_ID_Number | ID Number of 3V. |
| 9 | String (10) | Merchant_ID | ID of merchant where 3V |
| | | | was sold. |
| 10 | Int (10,2) | Amount | Limit of 3V. |
| 11 | String (3) | Currency | Currency of 3V. |

The following represents the transaction table of the database 32.

| # | Type | Name | Description |
|---|---|---|---|
| 1 | Int (16) | ID | Automatically generated by database. |
| 2 | Int (16) | 3V_ID | ID of voucher. |
| 2 | String (1) | Type | P = Purchase of voucher. |
| | | | R = Redemption of voucher. |
| 3 | Date | Date | Date of Transaction. |
| 4 | Time | Time | Time of Transaction. |

Prior to requesting a voucher from the processor 30 the host 10 performs the following database operations via ODBC:
Check that a Cash_Customer_Table row exists where the ISC_ID matches the ISC_ID read from the magnetic stripe of the ISC card presented by the customer.
If the Status field of this row is 0 (‘Active’)
   Allow the transaction to proceed
Else
   Deny the transaction

After a voucher has been purchased, the EPOS Network performs the following database operations:

Insert a new row into the 3V_Table.

| Field | Value |
|---|---|
| PAN | From PROCESSOR |
| Expiry | From PROCESSOR |
| CVV | From PROCESSOR |
| Issue_Date | Current Date |
| Issue Time | Current Time |
| Type | ‘H’ if Cash voucher |
| | ‘D’ if Card voucher |
| Cash_Customer_ID | ID field of matching row |
| | in Cash_Customer_Table. |
| | (only if Type = ‘H’ above) |
| 3V_ID_Number | From PROCESSOR |
| Merchant_ID | EPOS Network ID of |
| | Merchant. |
| Amount | From PROCESSOR |
| Currency | ‘EUR’ |

Insert a new row into the Transaction Table.

| Field | Value |
|---|---|
| 3V_ID | ID From 3V_Table in |
| | previous transaction above. |
| Type | ‘P’ |
| Date | Current Date |
| Time | Current Time |

The processor 30 provides a website at which the host organisation can cancel a voucher, and review MIS information. Communication to this website is over HTTP with a URL of the form ‘http://www.3vcancel.com/’. This is redirected to a HTTPS URL of the form: ‘https://www.3vcancel.com/’. Appropriate SSL certificates are created and maintained by the processor 30.

At this point the host 10 enters a username and password and is invited to enter the voucher ID Number. After this is entered, the system responds with the current balance on the 3V and an invitation to cancel this voucher.

The processor 30 also provides a website at which a customer can enter the ‘ID Number’ associated with a voucher and receive back an up-to-date balance statement on that voucher. Communication to this website is over HTTP with a URL of the form ‘http://www.3vbalance.com/’. This should be redirected to a HTTPS URL of the form: ‘https://www.3vbalance.com/’. Appropriate SSL certificates are created and maintained by the processor 30.

At this point the customer is invited to enter the voucher ID Number. After this is entered, the system responds with the current balance on the voucher. The customer can then continue to enter more ID Numbers and receive the current balance for each. The website should log the customer out after 2 minutes of inactivity.

All communication between the EPOS host 10 and the processor 30 uses an SSL based HTTP interface over the Internet. In this interface, the processor 30 acts as HTTPS server, and the EPOS host 30 act as HTTPS client using a port on the server side. The processor 30 supplies certificates that are required by the EPOS host 10.

The EPOS host 10 can be located anywhere, and it supplies a set of public IP addresses from which all connections to the processor will be made.

The logical interface consists of function calls and parameters which can be called over the HTTPS interface.

Functions and Parameters, including a username and password are sent to the processor via URL encoded parameters.

Eg:

https://1.2.3 4/CL_LoadValue.asp?userid=uid&pwd=xxx&cardnum=11112222333 34444&purseno=99&amt=9.99&sourceid=30

The response to each HTIP request is text based.

2: Operation Successfil

It is the duty of EPOS host 10 to recognise a connection failure. This is detected by the EPOS host 10 through a HTTPS error or/and a timeout of 10 seconds.

When detected, the operation is retried a second time and if the connection fails again, then the operation is reported as failed to the terminal.

Communication with the host 10 database uses ODBC Version 2. The EPOS host 10 supplies a local LAN ip address which will be used on database server.

The invention provides for vouchers which are automatically generated at any participating merchant using existing point-of-sale hardware. There is no need for the customer to have a credit card account, and there is little need to worry that the number may be misappropriated as the voucher only has a limited value. The use of a security card as described helps to ensure traceability, thus deterring money laundering and other illegal use of the vouchers. Also, because the voucher data is transmitted to the customer via two separate channels the risk of fraud is further minimised. It will also be appreciated that implementation of the invention can be achieved with little additional hardware equipment. The point-of-sale terminals, the point-of-sale network, some of the EPOS host hardware, some of the processor hardware, and the CNP merchant systems exist already. A further advantage is the dual purpose of the security card, providing both security by way of customer validation and also automatic launching of the point-of-sale merchant interface. This minimises merchant staff training required, and helps to ensure integrity of the voucher generation operations. This is particularly important as a wide variety and large number of merchants may be involved in issuing vouchers.

The invention is not limited to the embodiments described but may be varied in construction and detail. For example, the processor 30 may comprise any appropriate number of interlinked local or remote systems.

1-26. (canceled)

27. A method of generating a payment instrument voucher for use in card-not-present transactions such as online transactions, the method comprising the steps of:
a point-of-sale terminal in a retailer premises receiving customer security data;
the point-of-sale terminal communicating with a remote host to validate the customer security data;
if validation is positive, the point-of-sale terminal receiving voucher request data;
the point-of-sale terminal transmitting a voucher request message to the remote host, and the host responding with a request response; and
the point-of-sale terminal outputting voucher data in return for receiving payment by the customer, if the host response is positive;
wherein the host generates a full set of voucher data, transmits a first set of the voucher data to the point-of-sale terminal, and transmits a second set of the voucher data directly to the customer; and wherein the first set of voucher data includes a voucher number and the second set includes a voucher security code;
wherein the customer security data is read from a card presented by the customer and having the security data recorded thereon;
wherein the step of the host generating the voucher data includes: transmitting a voucher request message to a transaction processor, the transaction processor allocating a voucher number, the transaction processor returning the voucher number to the host; and
wherein the method comprises the further steps of the transaction processor receiving a request for validation of the voucher for a proposed transaction from a card-not-present merchant system, verifying the voucher number, and transmitting a message to the host to indicate that the voucher has been used or partly used.

28. The method as claimed in claim 27, wherein the host generates a full set of voucher data, transmits a first set of the voucher data to the point-of-sale terminal, and transmits a second set of the voucher data directly to the customer.

29. The method as claimed in claim 27, wherein the host generates a full set of voucher data, transmits a first set of the voucher data to the point-of-sale terminal, and transmits a second set of the voucher data directly to the customer; and wherein the second set is transmitted as a message to a customer's mobile device.

30. The method as claimed in claim 27, wherein the host generates a full set of voucher data, transmits a first set of the voucher data to the point-of-sale terminal, and transmits a second set of the voucher data directly to the customer; and wherein the second set is transmitted as a message to a customer's mobile device; and wherein the message is an SMS message.

31. The method as claimed in claim 27, wherein the host generates a full set of voucher data, transmits a first set of the voucher data to the point-of-sale terminal, and transmits a second set of the voucher data directly to the customer; and
wherein the host includes a gateway linked with a mobile telecommunications network for transmitting the second set of voucher data.

32. The method as claimed in claim 27, wherein the point-of-sale terminal prints the terminal voucher data.

33. The method as claimed in claim 32, wherein the terminal prints the voucher data to provide a physical printed voucher.

34. The method as claimed in claim 27, wherein the customer security data is read from a card presented by the customer and having the security data recorded thereon; and wherein the security data is magnetically encoded on the card.

35. The method as claimed in claim 27, wherein the customer security data is read from a card presented by the customer and having the security data recorded thereon; and wherein the card includes a trigger program, and the point-of-sale terminal executes said program to cause automatic activation of a voucher purchase launch program on the terminal.

36. The method as claimed in claim 27, wherein the customer security data is read from a card presented by the customer and having the security data recorded thereon; and wherein the card includes a trigger program, and the point-of-sale terminal executes said program to cause automatic activation of a voucher purchase launch program on the terminal; and wherein the launch program automatically presents the point-of-sale operator with a menu of possible voucher values.

37. The method as claimed in claim 36, wherein the terminal (1) automatically generates a voucher request message for the host (10) using the security data and the value selection.

38. The method as claimed in claim 37, wherein the voucher request message includes only the security code and the requested voucher value.

39. The method as claimed in claim 27, wherein the host dynamically maintains a database of security data and a database of issued voucher data linked with the security data.

40. The method as claimed in claim 27, wherein the voucher request message transmitted to the host includes only a request code and the value.

41. The method as claimed in claim 27, wherein the transaction processor allocates a PAN number as the voucher number, said number being suitable for processing in a subsequent transaction in a manner similar to that of a debit or credit card number.

42. The method as claimed in claim 27, wherein the host automatically updates a voucher database.

43. A method of operation of a transaction processor, comprising the steps of the processor: receiving a voucher request from a point-of-sale system, satisfying the request by generating or selecting a voucher number, transmitting the voucher number to the point-of-sale system, and updating a voucher database accordingly; subsequently, receiving a transaction request from a card-not-present merchant system, identifying a voucher number in the request, and determining if the transaction should be authorised according to the voucher database and a transaction database; and after completion of the transaction, transmitting a message to the host system including details of the transaction.

44. The method as claimed in claim 43, wherein the voucher request received from the point-of-sale system includes only a request indicator and a value indicator and is of common, fixed length format.

45. The method as claimed in claim 43, wherein the point-of-sale system is a point-of-sale host, in turn linked with a plurality of remote point-of-sale terminals.

46. The point-of-sale terminal comprising means for performing point-of-sale terminal operations of a method of claim 27.

47. The point-of-sale host comprises means for performing point-of-sale host operations of a method of claim 27.

48. The transaction processor comprises means for performing transaction processor operations of a method of claim 42.
